(19) United States
(12) Patent Application Publication
(10) Pub. No.: US 2017/0090691 A1
(43) Pub. Date: Mar. 30, 2017

(54) DISPLAY, NON-TRANSITORY COMPUTER READABLE MEDIUM, AND DISPLAY METHOD

(71) Applicant: FUJI XEROX CO., LTD., Tokyo (JP)

(72) Inventor: Norihiko TSUYUZAKI, Kanagawa (JP)

(73) Assignee: FUJI XEROX CO., LTD., Tokyo (JP)

(21) Appl. No.: 14/990,062

(22) Filed: Jan. 7, 2016

(30) Foreign Application Priority Data
Sep. 25, 2015 (JP) 2015-187936

(51) Int. Cl. G06F 3/0482

(52) U.S. Cl. CPC G06F 3/0482; G06F 2203/04803

(57) ABSTRACT

A display includes a receiving unit, a generation unit, and a display controller. The receiving unit receives an instruction for generating an information display screen displaying information to be processed and also receives screen display information regarding an elementary function, the information display screen being called and shared by multiple services, the elementary function being specific to a corresponding one of the services and displayed on the information display screen. The generation unit generates an elementary-function display screen on a basis of the screen display information. The display controller performs control to display the elementary-function display screen together with the information display screen.

### CROSS-REFERENCE TO RELATED APPLICATIONS

This application is based on and claims priority under 35 USC 119 from Japanese Patent Application No. 2015-187936 filed Sep. 25, 2015.

### BACKGROUND

(i) Technical Field

The present invention relates to a display, a non-transitory computer readable medium, and a display method.

(ii) Related Art

In an apparatus that provides various services, a process is executed in response to a selection of a desired service by a user, and results of the processing, log information, and the like are generated and recorded. The content of the information generated as a result of the service may be checked using check screens provided by information management functions (such as a job management function, a file management function, and an audit log management function) shared by multiple services.

Each check screen indicates a list of generated pieces of information and objects that are put together on a predetermined basis. Examples of the check screens include a job check screen on which processes from the start of a process request to the end of a series of processes are conceptualized as jobs and displayed as a list and a file check screen on which persistent files are displayed as a list. The check screen is provided with a function of further sorting or filtering pieces of information and a function of user operations related to the pieces of information displayed as the list. Since the information management function is shared by the services, the user operation function for the listed pieces of information provides function buttons that enable execution of processes shared by the services, the function buttons being provided for operations shared by the services, such as stopping a job and checking details of a file. The user operation function does not provide function buttons dependent on specific services.

### SUMMARY

According to an aspect of the invention, there is provided a display including a receiving unit, a generation unit, and a display controller. The receiving unit receives an instruction for generating an information display screen displaying information to be processed and also receives screen display information regarding an elementary function, the information display screen being called and shared by multiple services, the elementary function being specific to a corresponding one of the services and displayed on the information display screen. The generation unit generates an elementary-function display screen on a basis of the screen display information. The display controller performs control to display the elementary-function display screen together with the information display screen.

### BRIEF DESCRIPTION OF THE DRAWINGS

Exemplary embodiments of the present invention will be described in detail based on the following figures, wherein:

FIG. 1 is a block configuration diagram illustrating an exemplary embodiment of a common-screen display according to the invention;

FIG. 2 is a hardware configuration diagram of a computer serving as the common-screen display in the exemplary embodiment;

FIG. 3 is a table illustrating an example of the data configuration of parameter information in the exemplary embodiment;

FIG. 4 is a table illustrating an example of the data configuration of function-button information in the exemplary embodiment;

FIG. 5 is a diagram illustrating an example of displaying a menu screen in the exemplary embodiment;

FIG. 6 is a diagram illustrating an example of displaying a service menu screen in the exemplary embodiment;

FIG. 7 is a diagram illustrating an example of displaying a job check screen in the exemplary embodiment;

FIG. 8 is a flowchart illustrating a process of displaying a job check screen in the exemplary embodiment;

FIG. 9 is a flowchart illustrating a function-button selection process in the exemplary embodiment;

FIG. 10 is a flowchart illustrating a user-operation reception process in the exemplary embodiment; and

FIG. 11 is a table that is an example of a processing-condition table set in the exemplary embodiment.

### DETAILED DESCRIPTION

Hereinafter, an exemplary embodiment of the invention will be described with reference to the drawings.

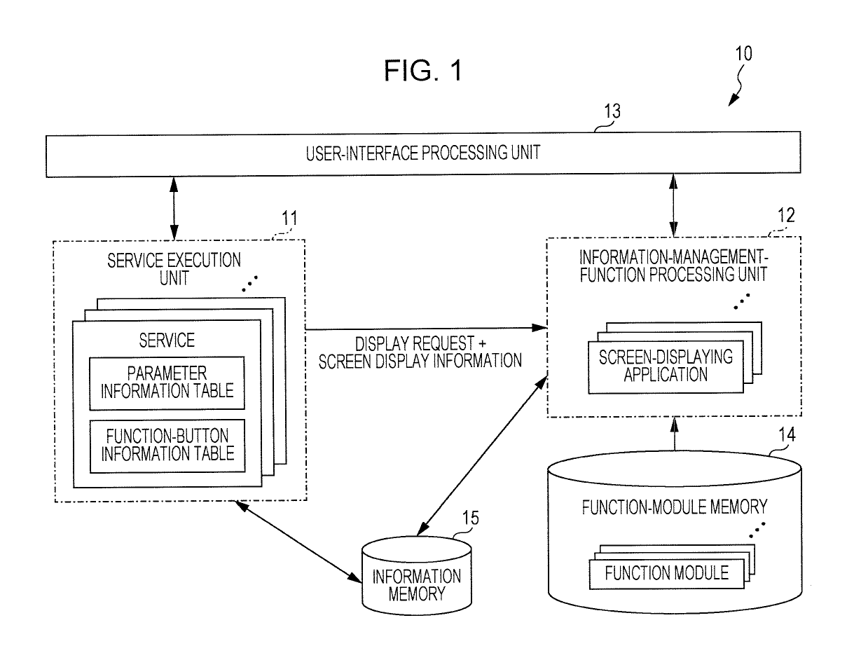

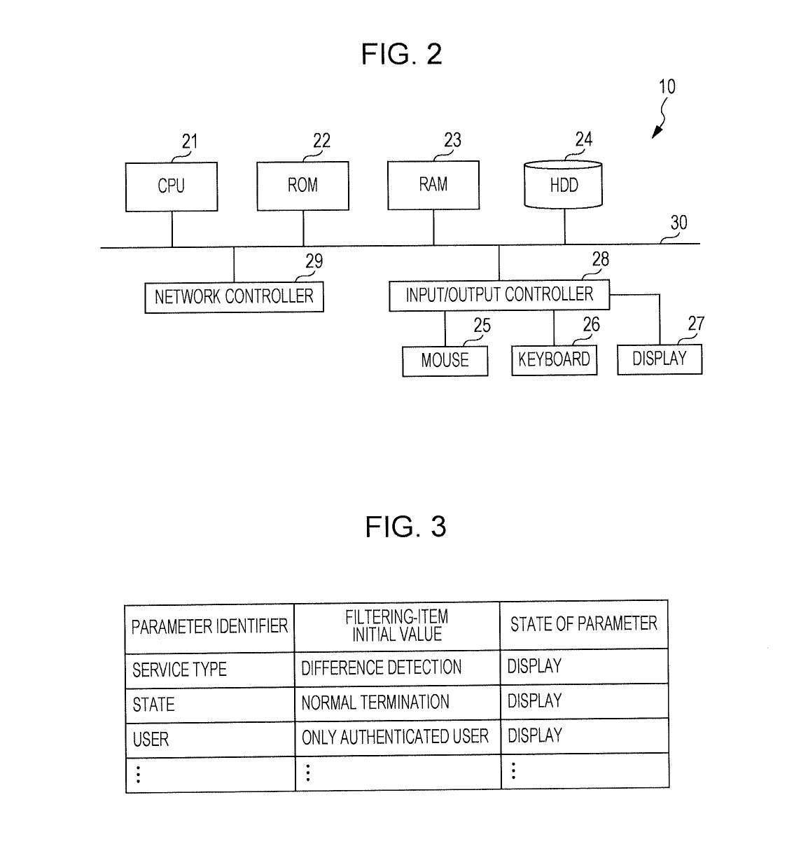

FIG. 1 is a block configuration diagram illustrating an exemplary embodiment of a display according to the invention. FIG. 2 is a hardware configuration diagram of a computer serving as a common-screen display 10 in the exemplary embodiment. The computer serving as the common-screen display 10 in the exemplary embodiment may be implemented by using an existing general-purpose hardware configuration such as a personal computer (PC). Specifically, as illustrated in FIG. 2, the computer includes a central processing unit (CPU) 21, a read-only memory (ROM) 22, a random-access memory (RAM) 23, a hard disk drive (HDD) 24, an input/output controller 28, and a network controller 29 each of which is connected to an internal bus 30. The input/output controller 28 connects, to the computer, a mouse 25 and a keyboard 26 that are provided as input units and a display 27 provided as a display network. The network controller 29 is provided as a communication unit.

Referring back to FIG. 1, the common-screen display 10 in the exemplary embodiment includes a service execution unit 11, an information-management-function processing unit 12, a user-interface processing unit 13, a function-module memory 14, and an information memory 15. The service execution unit 11 provides services by running service applications loaded in the common-screen display 10. Since each service is provided by running the corresponding service application, the terms “service application” and “service” have almost the same meaning in the exemplary embodiment and are thus interchangeable. Each service application has parameter information and function-button information each of which is stored in a table. The information will be described later.

The information-management-function processing unit 12 runs screen-displaying applications. Each screen-displaying application has been prepared as a common application called from multiple services. Upon receiving an instruction for generating an information display screen displaying information to be processed and also receiving screen display information regarding an elementary function to be displayed on the information display screen, the screen-displaying application generates an elementary-function display screen on the basis of the screen display information and performs control to display, on the user-interface processing unit 13, the elementary-function display screen together with the information display screen. Examples of information display screens generated by the screen-displaying application include a file check screen for displaying a file list and a job check screen for displaying a job list.

The function-module memory 14 is used to store function modules that are each called from the corresponding screen-displaying application and that are each run when a corresponding function button is selected. The user-interface processing unit 13 displays, on the display 27, a menu screen for selecting a desired service and the information display screen generated by the information-management-function processing unit 12. The user-interface processing unit 13 also receives a user operation performed by using the mouse 25 and the keyboard 26 or by touching the display 27. The information memory 15 is used to store various pieces of information held and managed by the common-screen display 10.

The service execution unit 11, the information-management-function processing unit 12, and the user-interface processing unit 13 of the common-screen display 10 are implemented through cooperative operations between the computer serving as the common-screen display 10 and a program run by the CPU 21 included in the computer. The function-module memory 14 and the information memory 15 are implemented by the HDD 24 included in the common-screen display 10. Alternatively, the RAM 23 or a memory in an external apparatus may be used through a network.

Programs used in the exemplary embodiment may be provided through not only a communication unit but also in such a manner as to be stored in a computer readable recording medium such as a compact disc ROM (CD-ROM) and a universal serial bus (USB) memory. The programs provided through the communication unit or the recording medium are installed on the computer, and the CPU 21 of the computer runs the programs serially to implement various processes.

On an information display screen displayed by an information management function shared by services, function buttons only for a process shared and executed by the services have been displayed, and operations only common to the services have thus been enabled. However, function buttons specific to a service are actually needed in some cases because the content of a desired process to be executed from the information display screen varies with the type of service. For example, a specific service is desirably provided with a function by which all the files generated in a job in the specific service are collectively deleted when the job is checked.

A conceivable way of satisfying this is to provide function buttons for all of the services on the common information display screen. However, this results in a huge number of function buttons being displayed on the information display screen and, even function buttons that are not usable for a specific service are displayed. Sharing the information management function contrarily inconveniences a user. In addition, generation of the information management function for each service leads to generation of multiple similar information display screens. This might also confuse the user and increase the development cost because the multiple similar information display screens are individually developed.

In the exemplary embodiment, when being used at the time of executing a service, a common information management function is notified of elementary functions such as service-specific function buttons desirably used by the service. The information management function thereby displays the elementary functions desirably used by the service. In other words, the service may customize the functionality of the common information management function. The information management function executes processes in such a manner as to display the elementary functions desirably used by the service in accordance with screen display information regarding the elementary functions, the screen display information being received together with an instruction from the service for generating an information display screen. Accordingly, when being used for another service, the elementary functions desirably used by the service are not displayed by the information management function.

Parameter information and function-button information delivered by the service to the information management function will be described.

FIG. 3 is a table illustrating an example of the data configuration of parameter information in the exemplary embodiment. As the parameter information, information regarding filtering and sorting are set. The parameter information includes an identifier (parameter identifier) uniquely representing a parameter, an initial value of the parameter (filtering-item initial value), and the state of the parameter. As the state of the parameter, there is set “Display” in which the parameter is displayed on the display, “Non-display” in which the parameter is not displayed on the display, or “Disable” in which set values are displayed on the display but are not changeable.

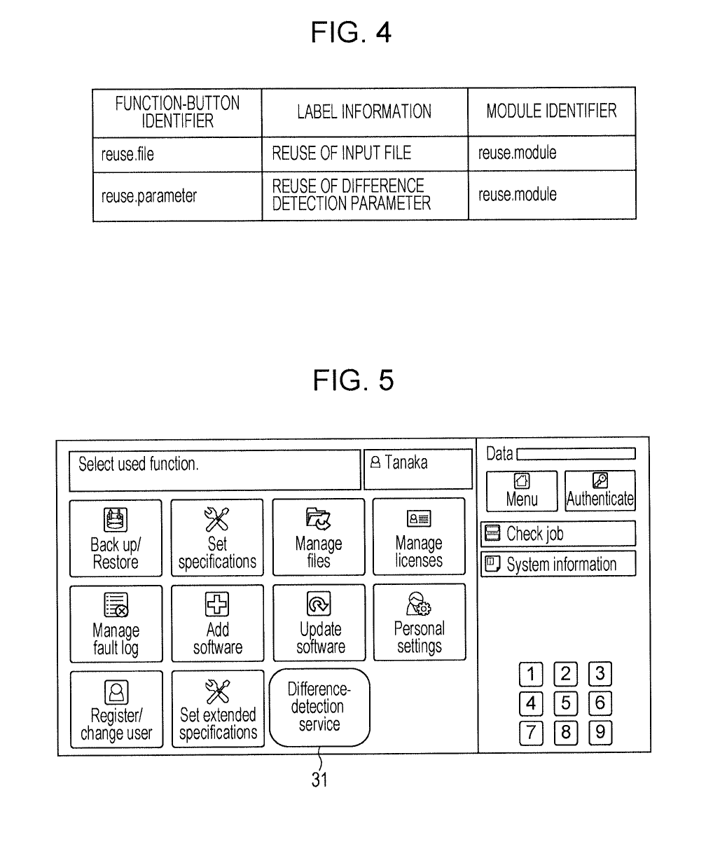

FIG. 4 is a table illustrating an example of the data configuration of service-specific function-button information in the exemplary embodiment. As the function-button information, information regarding function buttons to be displayed is set. The function-button information includes an identifier (function-button identifier) identifying a function button, label information assigned to the function button, and an identifier (module identifier) uniquely identifying a function module associated with the function button.

In the exemplary embodiment, function buttons are displayed on the function button display screen (described later) in the same order as in the function-button information table. However, the display arrangement order may be controlled. For example, a function of changing the arrangement order may be provided to services, or numbers representing the arrangement order may be assigned to pieces of function-button information.

Operations in the exemplary embodiment will next be described. First, transition of a screen displayed on the display 27 is described to thereby explain operations in the exemplary embodiment in a user scenario.

A user performs an operation to display the menu screen as illustrated in FIG. 5 on the display 27. The user selects a service to be used on the menu screen. In this case, the user selects a difference-detection service button 31 to use a “difference-detection service”.

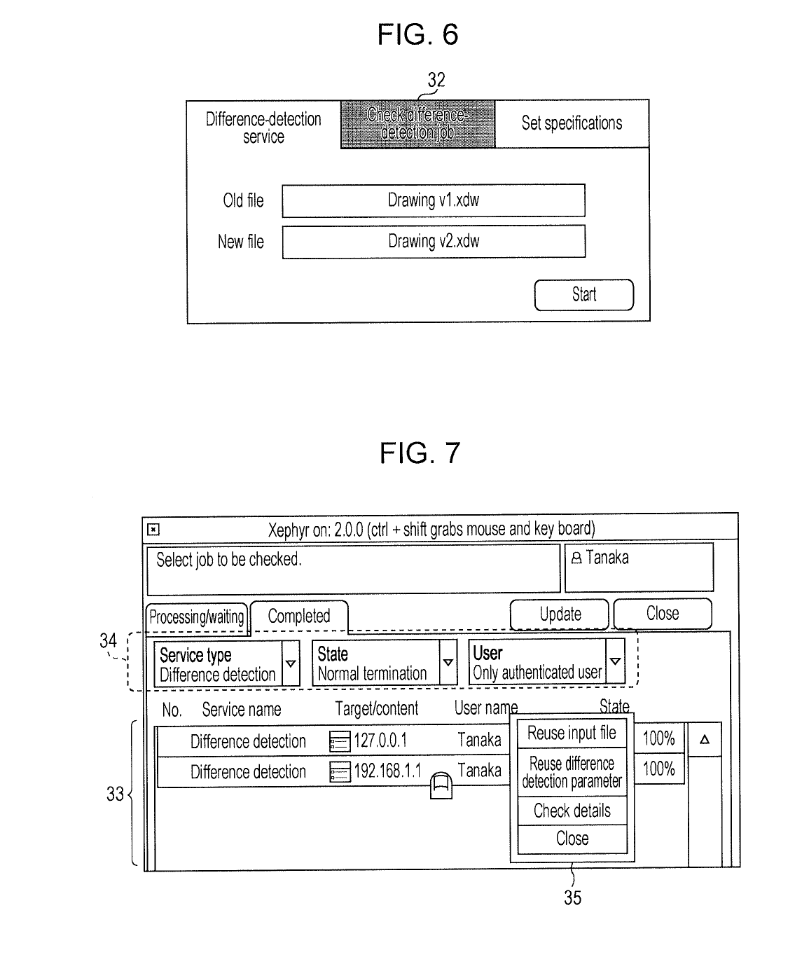

In response to the selection operation, the service execution unit 11 starts the difference-detection service. The difference-detection service displays the service menu screen illustrated in FIG. 6 on the display 27. Actually, the user-interface processing unit 13 receives the user operation, and various screens are displayed on the display 27 under the display control performed by the service execution unit 11 and the information-management-function processing unit 12. However, for convenience in the following description, the screens are displayed by the service application and the screen-displaying application.

To check a difference-detection job on the service menu, the user selects a “Check difference-detection job” tab 32 to change the display screen and then selects the OK button on the new screen. The job check screen illustrated in FIG. 7 subsequently appears. The job check screen includes a job-list display region 33, a parameter-information display region 34, and a function-button display screen 35 that is superposed on the job check screen in accordance with the user operation.

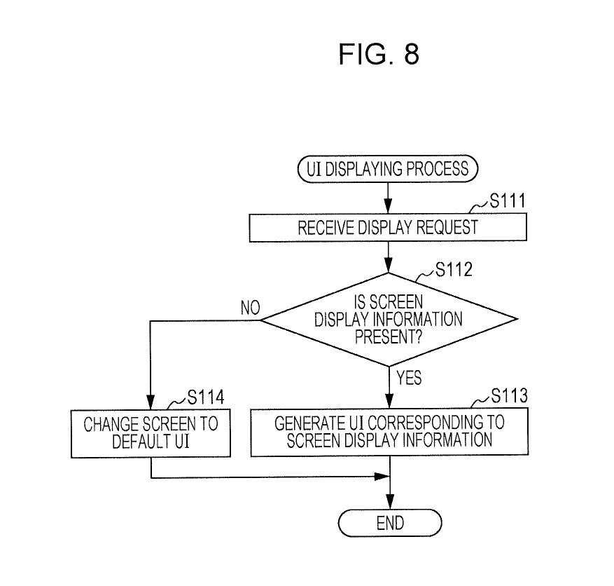

Hereinafter, a process of displaying the job check screen in the exemplary embodiment will be described by using the flowchart illustrated in FIG. 8.

When the “Check difference-detection job” tab 32 is selected on the service menu screen illustrated in FIG. 6, the difference-detection service transmits a request for displaying the job check screen to the information-management-function processing unit 12 to thereby give an instruction for displaying the job check screen. At this time, the difference-detection service also extracts the internally held function-button information and parameter information from the respective tables and transmits the extracted information as the screen display information together with the display request.

Upon receiving the display request from the difference-detection service (S111), the information-management-function processing unit 12 starts the screen-displaying application that displays the job check screen. When being started, the screen-displaying application (hereinafter, referred to as a “job-check-screen displaying application”) displays a predetermined job check screen (default user interface (UI) screen). However in the exemplary embodiment, if the job-check-screen displaying application receives the screen display information together with the display request (YES in S112), the job-check-screen displaying application generates a job check screen (FIG. 7) corresponding to the screen display information (S113).

Specifically, the job-check-screen displaying application refers to the parameter information and displays the parameter-information display region 34. Referring to the parameter information illustrated in FIG. 3, the job-check-screen displaying application forms display regions in accordance with parameters of “Service type”, “State”, and “User” for each of which “Display” is set as the state of the parameter. Initial values set for the parameter information are displayed in the respective display regions.

The job-check-screen displaying application also refers to the function-button information and generates and displays the function-button display screen 35. The exemplary embodiment assumes that selection of a job from the job list causes displaying of the function-button display screen 35. However, the function-button display screen 35 may be incorporated into the information display screen to be displayed at all times. When to display function buttons depends on the specifications of the information display screen (the function of the screen-displaying application).

The function-button display screen 35 includes function buttons of “Check details” and “Close” that are not included in the function-button information illustrated in FIG. 4. The function-button display screen 35 may include, in this manner, function buttons that are common to all of the services and that are not dependent on the service calling the job-check-screen displaying application.

In contrast, if the job-check-screen displaying application does not receive the screen display information (NO in S112), the job-check-screen displaying application displays a job check screen provided in advance as the default UI screen (S114).

The screen-displaying application in the exemplary embodiment generates and displays the information display screen in this manner on the basis of the screen display information received from the calling service. Processing in this manner prevents function buttons dependent on services other than the difference-detection service from being displayed on the job check screen displayed by the difference-detection service and, vice versa, prevents the function buttons dependent on the difference-detection service from being displayed on the job check screen displayed by the other services. For example, for a service that uses confidential documents, only secure function buttons are displayed on the file-list check screen of the service, and insecure function buttons are not displayed so as not to be used. More specifically, an e-mail forwarding button is not displayed on the file-list check screen of the service using confidential documents to prevent a confidential document from being accidentally transmitted.

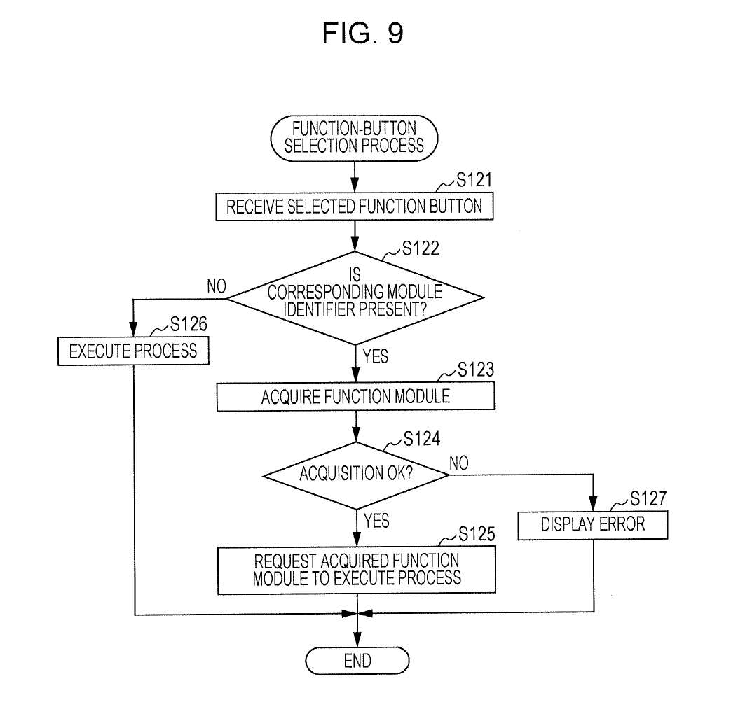

Subsequently, a function-button selection process performed when a function button is selected on the information display screen will be described by using the flowchart illustrated in FIG. 9.

When the user selects a function button on the function-button display screen 35, the screen-displaying application receives the selected function button (S121). The screen-displaying application subsequently refers to the function-button information and acquires a module identifier corresponding to the function button. If the screen-displaying application successfully acquires the module identifier (YES in S122), the screen-displaying application reads out the function module corresponding to the module identifier from the function-module memory 14 and acquires the function module (S123).

If the screen-displaying application successfully acquires the function module (YES in S124), the screen-displaying application transmits, to the function module, a process request including the button identifier of the selected function button and identification information (a job ID) uniquely identifying a job and thereby causes the function module to execute its process (S125). If the screen-displaying application fails to acquire the function module (NO in S124), the screen-displaying application displays an error indicating the content to that effect (S127).

If the screen-displaying application fails to acquire the module identifier from the function-button information (NO in S122), the job-check-screen displaying application executes a predetermined process corresponding to the selected function button (S126). The case where the screen-displaying application fails to acquire the module identifier corresponds to, for example, a case where the button of “Check details” or “Close” is selected in the example described above.

Note that function buttons do not necessarily have a one-to-one correspondence with function modules as illustrated in FIG. 4. Accordingly, to provide notification of which function (button) has been selected to a function module, the screen-displaying application delivers the button identifier of the selected function button to the function module. However, the function buttons may have a one-to-one correspondence with the function modules. In this case, the module identifiers may be used as the button identifiers. In addition, the module identifiers may be omitted in the function-button information.

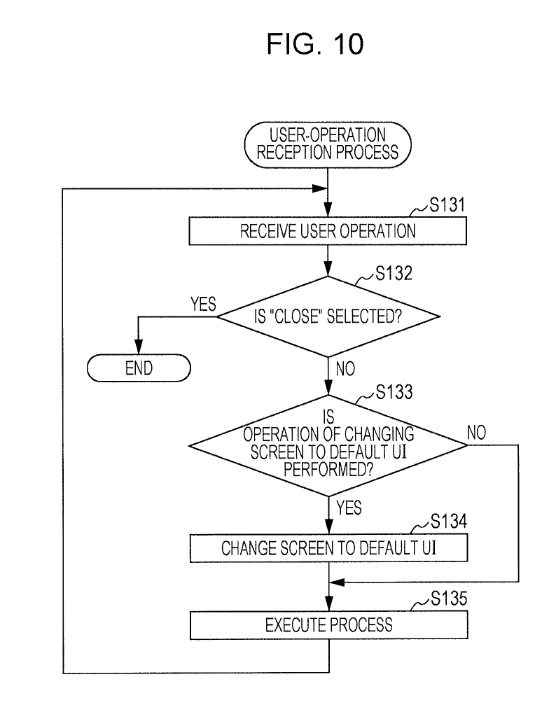

Subsequently, a user-operation reception process performed at the time of an operation other than an operation of selecting a function button on the information display screen will be described by using the flowchart illustrated in FIG. 10.

When the user performs an operation on the information display screen, the screen-displaying application receives the operation (S131). If the operation is the operation of selecting the “Close” button on the information display screen (YES in S132), the screen-displaying application terminates the process. If the user operation is not the operation of selecting the “Close” button on the information display screen (NO in S132), and if the user operation is an operation of changing the information display screen to the default UI screen (YES in S133), the screen-displaying application changes the information display screen to the default UI screen (S134). In the example described above, the job-check-screen displaying application called by the difference-detection service changes, to the job check screen (default UI screen) prepared in advance to be shared by the services, the job check screen customized for the difference-detection service accompanied by the function-button display screen 35 that is generated on the basis of the screen display information received from the difference-detection service. The job-check-screen displaying application executes a process corresponding to the user operation (S135). If the user operation is not the operation of changing the information display screen to the default UI screen (NO in S133), the job-check-screen displaying application executes a process corresponding to the user operation (S135).

The “operation of changing the information display screen to the default UI screen” will be described.

In the exemplary embodiment as described above, when calling the screen-displaying application, the service delivers the screen display information to the screen-displaying application. The screen-displaying application generates the information display screen for displaying the parameter information and the function buttons on the basis of the received screen display information. In other words, because the screen-displaying application successfully receives the screen display information from the service, the screen-displaying application may generate the information display screen dependent on the service. For example, consider a case where the user changes the service type parameter illustrated in FIG. 7 from “Difference detection” to another service. At this time, the job-check-screen displaying application intends to display the information display screen for the new service but has not yet received the screen display information from the new service. Accordingly, the job-check-screen displaying application does not succeed in generating the information display screen customized for the new service and thus displays the default UI screen. In this example, an operation that leaves no option but to display the default UI screen, such as a user operation of changing the service type, corresponds to the “operation of changing the information display screen to the default UI screen”.

In contrast, for example, a user operation of changing the state of the parameter from “Normal termination” to “Abnormal termination” does not correspond to the “operation of changing the information display screen to the default UI screen” because just different jobs are displayed in the job-list display region 33 of the currently displayed job check screen. However, the configuration or the arrangement order of the function buttons may be changed in accordance with a change of parameter set values.

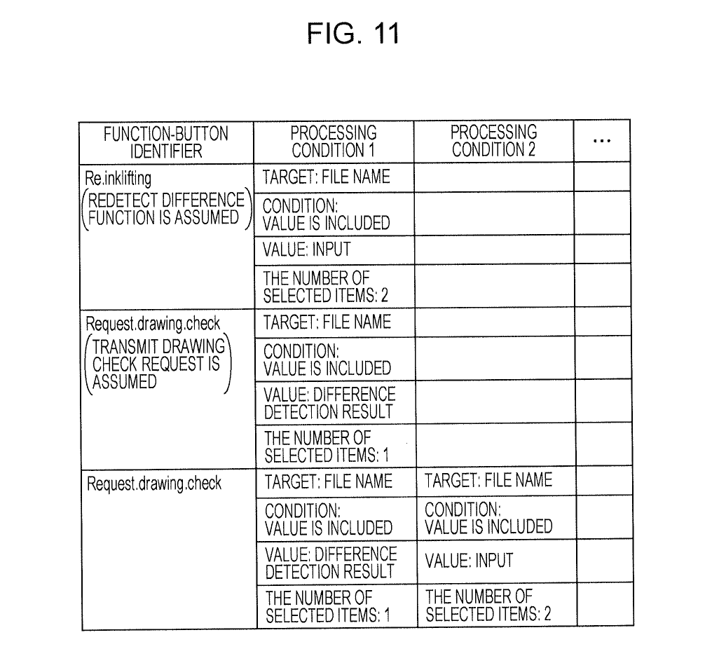

Meanwhile, a condition (processing condition) for allowing a function module associated with the function button to execute the corresponding process at the time of selection of a function button may be set. FIG. 11 is a table that is an example of a processing-condition table in which processing conditions in the exemplary embodiment are set. In the processing-condition table, function-button identifiers are set in association with the processing conditions.

For example, if two items each having a file name including “input” are selected, a “Redetect difference” button is enabled to execute the corresponding process. If one item having a file name including “difference detection result” is selected, or if one item having a file name including “difference detection result” and two items each having a file name including “input” are selected, a “Transmit drawing check request” button is enabled to execute the corresponding process. For example, when wishing to use the Redetect difference function, the user selects two files. If each of the file names of the two selected files does not include “difference detection result”, or if each of the two file names does not include “difference detection result” and at least one of the two file names does not include “input”, the state of the parameter for the “Redetect difference” button is Disable not to allow the “Redetect difference” button to be selected.

Multiple processing conditions may be designated. The processing conditions in FIG. 11 are examples, and other conditions may be set. A date and time may be set as the processing condition, such as a condition in which an update date is from January 2014 to January 2015. The expression of the processing conditions depends on the called information management function. For example, an identification number may be designated as the processing condition in a job management function.

As in step S114 in FIG. 8 or step S134 in FIG. 10, the screen-displaying application executes the process of changing the information display screen to the default UI screen at its own discretion in some cases, not in accordance with an instruction from the service. At this time, there is only a little possibility that the information display screen is not changed to the default UI screen for some reason or that a function button dependent on a specific service is still selectable even after the change.

Hence, in the exemplary embodiment, the processing conditions may be set for a function button as described above to prevent the function button from being accidentally selected.

In the configuration in the exemplary embodiment, each service holds the screen display information including the parameter information and the function-button information and directly transmits the screen display information to the screen-displaying application when calling the screen-displaying application. However, the exemplary embodiment is not necessarily limited to such a configuration. The service and the screen display information may simply be associated with each other. For example, the screen display information is stored in a memory outside the service in association with a service ID. When the service delivers a display request to the screen-displaying application, the service or another function also extracts the screen display information from the memory storing the screen display information and delivers the screen display information to the screen-displaying application.

In the exemplary embodiment, the description assumes a computer such as a PC as a service providing apparatus, but an image forming apparatus such as a multifunction printer having multiple service functions to provide a user with services may serve as the service providing apparatus.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display comprising:
a receiving unit that receives an instruction for generating an information display screen displaying information to be processed and that also receives screen display information regarding an elementary function, the information display screen being called and shared by a plurality of services, the elementary function being specific to a corresponding one of the services and displayed on the information display screen;
a generation unit that generates an elementary-function display screen on a basis of the screen display information; and
a display controller that performs control to display the elementary-function display screen together with the information display screen.

2. The display according to claim 1,
wherein the screen display information includes filtering information serving as a condition for selecting information to be displayed on the information display screen.

3. The display according to claim 1,
wherein only when a processing condition for executing a function module associated with the elementary function is satisfied, the display controller displays the elementary function to enable selection of the elementary function.

4. A non-transitory computer readable medium storing a program causing a computer to execute a process comprising:
receiving an instruction for generating an information display screen displaying information to be processed and also receiving screen display information regarding an elementary function, the information display screen being called and shared by a plurality of services, the elementary function being specific to a corresponding one of the services and displayed on the information display screen;
generating an elementary-function display screen on a basis of the screen display information; and
performing control to display the elementary-function display screen together with the information display screen.

5. A display method comprising:
receiving an instruction for generating an information display screen displaying information to be processed and also receiving screen display information regarding an elementary function, the information display screen being called and shared by a plurality of services, the elementary function being specific to a corresponding one of the services and displayed on the information display screen;
generating an elementary-function display screen on a basis of the screen display information; and
performing control to display the elementary-function display screen together with the information display screen.
